(19) United States
(12) Patent Application Publication
(10) Pub. No.: US 2020/0008372 A1
(43) Pub. Date: Jan. 9, 2020

(54) Culture Medium Comprising Microfibrillated Cellulose

(71) Applicant: Stora Enso OYJ, Helsinki (FI)

(72) Inventors: Kaj Backfolk, Villmanstrand (FI); Isto Heiskanen, Imatra (FI); Esa Saukkonen, Lappeenranta (FI); Elina Skerfe, Harplinge (SE)

(73) Assignee: Stora Enso OYJ, Helsinki (FI)

(21) Appl. No.: 16/489,817

(22) PCT Filed: Feb. 27, 2018
(86) PCT No.: PCT/IB2018/051217

§ 371 Date: Aug. 29, 2019

(30) Foreign Application Priority Data
Mar. 1, 2017 (SE) 1750218-8

(51) Int. Cl. A01G 24/35; A01G 24/18; A01G 24/15; A01G 24/28; A01G 24/25; A01G 24/23

(52) U.S. Cl. CPC A01G 24/35; A01G 24/18; A01G 24/23; A01G 24/28; A01G 24/25; A01G 24/15

(57) ABSTRACT

The present invention is directed to a culture medium comprising a soilless substrate, microfibrillated cellulose and a hydrophilic or amphiphilic polymer. The present invention is particularly useful in soilless agriculture, such as for horticultural/agricultural use that is based on a soilless substrate such as mineral or glass wool. These types of culture media are often used in greenhouses but may also be used for outdoor horticulture or agriculture.

### TECHNICAL FIELD

The present invention is directed to a culture medium comprising a soilless substrate, microfibrillated cellulose and a hydrophilic or amphiphilic polymer. The present invention is particularly useful in soilless agriculture, such as for horticultural/agricultural use that is based on a soilless substrate such as mineral or glass wool. These types of culture media are often used in greenhouses but may also be used for outdoor horticulture or agriculture.

### BACKGROUND

Culture media comprising soilless substrates such as mineral wool, glass wool or other materials are often used in soilless cultivation, such as in greenhouses but also for outdoor use. One benefit of soilless cultivation is that it helps avoid soil-borne diseases.

The culture media typically comprise substrates such as mineral wool, glass wool, expanded clay, growstones, coir peat or coco peat, rice husks, perlite, vermiculite, pumice, sheep wool, rock wool, brick shards, wood shavings (which may be chemically and/or thermally modified), wood fiber or other natural fibers or polystyrene.

The problem with these types of culture media based is that they typically have poor water retention and it is necessary to deliver water to the plants at controlled rate or conditions. The water that is being added typically evaporates quickly from the culture medium. To the extent binders are used to bind together the components substrate components, the binders are typically synthetic and may be hydrophobic, thereby further reducing the water retention of the culture medium.

One solution has been to use anionic surfactants, which improve the wetting and the hydrophilicity of the substrate. These chemicals, however, may also have some drawbacks such as costs, or loss of efficiency as a function of time or when certain nutrients are added to the culture medium.

One problem with existing growth media is that they deteriorate over time. Typically, growth media are only used for one or two seasons and will then need to be replaced.

WO2004098270 is directed to a hydroponic growth medium, particularly a multilayered growth medium of cellulose fibers or polyester fibers.

US2016/0219810 is directed to a growth medium based sphagnum moss and the use of a foam-laid method for its manufacture. The sphagnum moss is typically strongly acidic and the exact contents of the moss varies. To the extent fibers are used, they are provided in the form of a foamed dispersion and a product comprising at least two layers is obtained. Sphagnum moss typically comprises living plants, twigs, roots, branches and the like.

There is a need for improved culture media, particularly culture media that are improvements over the existing mineral or glass based substrates.

### SUMMARY OF THE INVENTION

It has surprisingly been found that by adding microfibrillated cellulose (MFC) and at least one hydrophilic or amphiphilic polymer to a substrate suitable for soilless cultivation, it is possible to improve water retention capacity as well as reduce the need of petroleum based chemicals required as a binder for the culture medium. The microfibrillated cellulose and polymer may also facilitate adhesion between elements of the culture medium, such as adhesion between fibers of the substrate used in the culture medium.

The present invention is thus directed to a culture medium for soilless cultivation comprising a non-soil based substrate, microfibrillated cellulose and at least one hydrophobic polymer.

The substrate used in accordance with the present invention is any substrate suitable for soilless cultivation. The substrate may be organic or inorganic. The substrate may be a natural product or synthetic. Examples of such substrates are mineral wool, glass wool, expanded clay, growstones, coir peat or coco peat, rice husks, wood shavings (that may be native or chemically and/or thermally modified), wood fibers or other natural fibers, perlite, vermiculite, pumice, sheep wool, rock wool, brick shards or polystyrene. In one embodiment, the substrate is a synthetic substrate such as mineral wool or glass wool.

The microfibrillated cellulose useful in accordance with the present invention is optionally modified or derivatised using methods known in the art, to further increase its hydrophilic or amphiphilic character. Examples of such modifications or derivatisation includes carboxylation and TEMPO oxidation of the microfibrillated cellulose. Further examples of such modification or derivatization of the microfibrillated cellulose includes phosphorylation, sulfonation, methylation, carboxymethylation, acetylation. The microfibrillated cellulose may also be crosslinked.

The hydrophilic or amphiphilic polymer used accordance with the present invention may be a naturally occurring polymer or a synthetic polymer. The polymer may also be crosslinked.

The hydrophilic polymer used in accordance with the present invention is any hydrophilic polymer suitable for use in soilless culture. Examples of hydrophilic polymers are dextran, oligosaccharides, polysaccharides, starch, protein, sodium carboxymethylcellulose, cellulose derivatives, lignin, lignin derivatives, lignosulfonates, pectin and hemicellulose such as for example xylan or galactoglucomannan.

The amphiphilic polymer used in accordance with the present invention is any amphiphilic polymer suitable for use in soilless culture.

In one embodiment of the present invention, the culture medium is manufactured by mixing the substrate with the microfibrillated cellulose and polymer. The mixing can be done in an essentially liquid medium which is then subjected to drying to obtain the culture medium according to the present invention. Alternatively, the microfibrillated cellulose and polymer can be sprayed onto the substrate.

In one embodiment of the present invention, nutrients, salts, minerals, surfactants and other additives suitable for soilless cultivation are added when manufacturing the culture medium according to the present invention. In such embodiments, the additives are typically mixed with the substrate, microfibrillated cellulose and polymer prior to drying. Examples of additives include molasses and residual dissolved components from pulp and papermaking processes and cross-linked cellulose fibers. The culture medium obtained can readily be transported and stored in dry form. By adding water to a dried culture medium according to the present invention, the culture medium absorbs water and is swelling. The culture medium is then ready for use in soilless cultivation.

To control microbial activity, the culture medium may be exposed to treatments such as sterilization to reduce the amount of microorganisms present in the culture medium. Such treatment is typically carried out on the final product, but may also be carried out for each of the components, for example by sterilizing the substrate and the MFC separately, prior to the manufacture of the culture medium. To further provide control of microbial activity, antimicrobial agents may be added to the culture medium.

The pH of the growth medium according to the present invention is typically near neutral pH and the pH of the medium is preferably not adjusted by addition of acid or base during the process for manufacturing the culture medium.

One embodiment of the present invention is a method for increasing the water retention of a culture medium for soilless culture comprising the steps of providing a non-soil based substrate and mixing the substrate with microfibrillated cellulose and a hydrophilic or amphiphilic polymer. In one embodiment, the microfibrillated cellulose is provided to the culture medium as an aqueous solution or dispersion. In one embodiment, the microfibrillated cellulose is dissolved or dispersed in an aqueous solution or dispersion which is used to provide water during the soilless cultivation. In one embodiment, the aqueous solution or dispersion which is used to provide water during the soilless cultivation may also comprise hemicellulose and/or other components.

### DETAILED DESCRIPTION

The amount of microfibrillated cellulose used in the culture medium according to the present invention depends on the specific desired characteristics of the culture medium, but is generally in the range of from 1% to 75% by weight of the culture medium.

The amount of hydrophilic or amphiphilic polymer used in the culture medium according to the present invention depends on the specific desired characteristics of the culture medium, but is generally in the range of from 1% to 75% by weight of the culture medium, such as from 1% to 50% or from 1% to 25% or from 1% to 10% by weight of the culture medium.

The density of a dry culture medium according to the present invention is in the range of from 5 to 750 kg/m³, such as from 10 to 500 kg/m³ or from 20 to 250 kg/m³ or from 40 to 200 kg/m³ or from 50 to 150 kg/m³. The culture medium typically has a high porosity.

The microfibrillated cellulose used in the culture medium according to the present invention can be prepared using methods known in the art.

The amount of microfibrillated cellulose used in the culture medium is preferably in the range of from 1 to 50 wt-% of the dry weight of the culture medium, more preferably in the range of from 5 to 30 wt-%, such as from 5 to 20 wt-% of the dry weight of the culture medium.

Microfibrillated cellulose (MFC) shall in the context of the patent application mean a nano scale cellulose particle fiber or fibril with at least one dimension less than 100 nm. MFC comprises partly or totally fibrillated cellulose or lignocellulose fibers. The liberated fibrils have a diameter less than 100 nm, whereas the actual fibril diameter or particle size distribution and/or aspect ratio (length/width) depends on the source and the manufacturing methods.

The smallest fibril is called elementary fibril and has a diameter of approximately 2-4 nm (see e.g. Chinga-Carrasco, G., Cellulose fibres, nanofibrils and microfibrils,: The morphological sequence of MFC components from a plant physiology and fibre technology point of view, Nanoscale research letters 2011, 6:417), while it is common that the aggregated form of the elementary fibrils, also defined as microfibril (Fengel, D., Ultrastructural behavior of cell wall polysaccharides, Tappi J., March 1970, Vol 53, No. 3.), is the main product that is obtained when making MFC e.g. by using an extended refining process or pressure-drop disintegration process. Depending on the source and the manufacturing process, the length of the fibrils can vary from around 1 to more than 10 micrometers. A coarse MFC grade might contain a substantial fraction of fibrillated fibers, i.e. protruding fibrils from the tracheid (cellulose fiber), and with a certain amount of fibrils liberated from the tracheid (cellulose fiber).

There are different acronyms for MFC such as cellulose microfibrils, fibrillated cellulose, nanofibrillated cellulose, fibril aggregates, nanoscale cellulose fibrils, cellulose nanofibers, cellulose nanofibrils, cellulose microfibers, cellulose fibrils, microfibrillar cellulose, microfibril aggregrates and cellulose microfibril aggregates. MFC can also be characterized by various physical or physical-chemical properties such as large surface area or its ability to form a gel-like material at low solids (1-5 wt %) when dispersed in water. The cellulose fiber is preferably fibrillated to such an extent that the final specific surface area of the formed MFC is from about 1 to about 300 m²/g, such as from 1 to 200 m²/g or more preferably 50-200 m²/g when determined for a freeze-dried material with the BET method.

Various methods exist to make MFC, such as single or multiple pass refining, pre-hydrolysis followed by refining or high shear disintegration or liberation of fibrils. One or several pre-treatment step is usually required in order to make MFC manufacturing both energy efficient and sustainable. The cellulose fibers of the pulp to be supplied may thus be pre-treated enzymatically or chemically, for example to reduce the quantity of hemicellulose or lignin. The cellulose fibers may be chemically modified before fibrillation, wherein the cellulose molecules contain functional groups other (or more) than found in the original cellulose. Such groups include, among others, carboxymethyl (CM), aldehyde and/or carboxyl groups (cellulose obtained by N-oxyl mediated oxydation, for example “TEMPO”), or quaternary ammonium (cationic cellulose). After being modified or oxidized in one of the above-described methods, it is easier to disintegrate the fibers into MFC or nanofibrillar size fibrils.

The nanofibrillar cellulose may contain some hemicelluloses; the amount is dependent on the plant source. Mechanical disintegration of the pre-treated fibers, e.g. hydrolysed, pre-swelled, or oxidized cellulose raw material is carried out with suitable equipment such as a refiner, grinder, homogenizer, colloider, friction grinder, ultrasound sonicator, fluidizer such as microfluidizer, macrofluidizer or fluidizer-type homogenizer. Depending on the MFC manufacturing method, the product might also contain fines, or nanocrystalline cellulose or e.g. other chemicals present in wood fibers or in papermaking process. The product might also contain various amounts of micron size fiber particles that have not been efficiently fibrillated. MFC is produced from wood cellulose fibers, both from hardwood or softwood fibers. It can also be made from microbial sources, agricultural fibers such as wheat straw pulp, bamboo, bagasse, or other non-wood fiber sources. It is preferably made from pulp including pulp from virgin fiber, e.g. mechanical, chemical and/or thermomechanical pulps. It can also be made from broke or recycled paper.

The above described definition of MFC includes, but is not limited to, the new proposed TAPPI standard W13021 on cellulose nanofibril (CMF) defining a cellulose nanofiber material containing multiple elementary fibrils with both crystalline and amorphous regions.

In one embodiment of the present invention, the MFC used may be freeze-dried or otherwise dried by sublimation. The MFC may act as a superabsorbent in the culture medium to reduce or totally replace the use of synthetic superabsorbents. In one embodiment of the invention, freeze-dried or sublimation-dried MFC can be added to the culture medium in dry form. MFC can also be added by using a solvent which enables maintenance of high absorptivity such that the MFC is solvent exchanged and dried prior to dry addition to the culture medium.

Suitable substrates for the culture medium are well known and can be prepared using methods known in the art.

In view of the above detailed description of the present invention, other modifications and variations will become apparent to those skilled in the art. However, it should be apparent that such other modifications and variations may be effected without departing from the spirit and scope of the invention.

1. A culture medium for soilless cultivation comprising a non-soil based substrate, microfibrillated cellulose and at least one hydrophilic or amphiphilic polymer, wherein the density of the culture medium when dry is in the range of from 5 to 750 kg/m³.

2. A culture medium according to claim 1, wherein the non-soil based substrate is mineral wool, glass wool, expanded clay, growstones, coir peat or coco peat, rice husks, perlite, vermiculite, pumice, sheep wool, rock wool, brick shards, wood shavings.

3. A culture medium according to claim, wherein the non-soil based substrate is synthetic.

4. A culture medium according to claim 3, wherein the non-soil based substrate is mineral wool or glass wool.

5. A culture medium according to claim 1, wherein the polymer is amphiphilic.

6. A culture medium according to claim 1, wherein the polymer is hydrophilic.

7. A culture medium according to claim 6, wherein the hydrophilic polymer is selected from dextran, an oligosaccharide, a polysaccharide, starch or hemicellulose.

8. A culture medium according to claim 1, wherein the microfibrillated cellulose is modified or derivatised to increase its hydrophilicity.

9. A culture medium according to claim 8, wherein the microfibrillated cellulose has been carboxylated, phosphorylated, sulfonated, methylated, carboxymethylated or TEMPO oxidized.

10. A culture medium according to claim 1, wherein the amount of microfibrillated cellulose is in the range of from 1% to 75% by weight of the dry culture medium.

11. A culture medium according to claim 1, wherein the amount of polymer is in the range of from 1% to 75% by weight of the dry culture medium.

12. Method for increasing the water retention of a culture medium for soilless culture comprising the steps of providing a non-soil based substrate and mixing the substrate with microfibrillated cellulose and a hydrophilic or amphiphilic polymer.

13. Method according to claim 12, wherein the microfibrillated cellulose is provided to the culture medium as an aqueous solution or dispersion.

14. Method according to claim 13, wherein the microfibrillated cellulose is dissolved or dispersed in an aqueous solution or dispersion which is used to provide water during the soilless cultivation.

15. A method for manufacturing a culture medium comprising the steps of
a) providing a suspension comprising microfibrillated cellulose and at least one hydrophilic or amphiphilic polymer in a liquid medium; and
b) applying the suspension from step a) on a non-soil based substrate suitable for use in a culture medium or mixing the suspension from step a) with a non-soil based substrate suitable for use in a culture medium.

16. A culture medium according to claim 2, wherein the non-soil based substrate is chemically and/or thermally modified, wood fiber or other natural fibers or polystyrene.

17. A method for manufacturing a culture medium according to claim, further comprising a step c) drying the product of step b).
